(19) United States
(12) Patent Application Publication
(10) Pub. No.: US 2021/0349582 A1
(43) Pub. Date: Nov. 11, 2021

(54) PAGE NAVIGATION WITH TREE MENU

(71) Applicants: Li ZHANG, Shanghai (CN); Bing ZHANG, Shanghai (CN); Da-Long SUN, Shanghai (CN); Rong-Feng CHEN, Shanghai (CN); MICRO FOCUS LLC, Provo, UT (US)

(72) Inventors: Li ZHANG, Shanghai (CN); Bing ZHANG, Shanghai (CN); Da-Long SUN, Shanghai (CN); Rong-Feng CHEN, Shanghai (CN)

(73) Assignee: MICRO FOCUS LLC, Santa Clara, CA (US)

(21) Appl. No.: 17/282,595

(22) PCT Filed: Oct. 5, 2018
(86) PCT No.: PCT/CN2018/109248

§ 371 Date: Apr. 2, 2021

(51) Int. Cl. G06F 3/0482; G06F 3/0483

(52) U.S. Cl. CPC G06F 3/0482; G06F 3/0483

(57) ABSTRACT

A computing device includes a processor and a machine-readable storage medium storing instructions. The instructions are executable by the processor to: generate a graphical user interface including a first portion and a second portion, the first portion including a tree menu comprising a plurality of topic links; and in response to a user selection of a first topic link in the tree menu, present a first topic window in the second portion of the graphical user interface. The instructions are further executable by the processor to, in response to a user command to minimize the first content window: minimize the first content window; and present a snapshot window in the second portion of the graphical user interface, the snapshot window comprising a first snapshot of the first topic window.

### BACKGROUND

Some computer systems provide access to information in the form of electronic files or documents. Such information may be presented in multiple sections that correspond to various subjects or topics. For example, an online manual for a software application may be organized in multiple webpages. The electronic form of such information may be stored locally in a database file, may be accessed from a remote location via a data network (e.g., the Internet), and so forth.

### BRIEF DESCRIPTION OF THE DRAWINGS

Some implementations are described with respect to the following figures.

FIG. 1 is a schematic diagram of an example system, in accordance with some implementations.

FIGS. 2A-2E are illustrations of an example user interface in accordance with some implementations.

FIG. 3 is an illustration of an example machine-readable storage medium storing instructions in accordance with some implementations.

FIG. 4 is a flow diagram of an example process for generating a graphical user interface in accordance with some implementations.

FIG. 5 is a schematic diagram of an example computing device in accordance with some implementations.

### DETAILED DESCRIPTION

Some computer applications may present information to a user in multiple graphical user interface (GUI) screens or “pages,” with each page focusing on a specific topic or knowledge area. For example, an online manual for a database application may include multiple pages to separately describe table creation, table modification, query execution, and so forth. Such pages may be organized in a hierarchical manner, with higher-level pages covering broad topics, and lower-level pages covering narrower sub-topics. In some situations, a user may need to jump between multiple pages to view information regarding various topics. However, when using several pages, the user may not be able to remember each page location, and thus may find it difficult to quickly navigate to each page as needed. Accordingly, the user may not be able to use the application in an efficient manner.

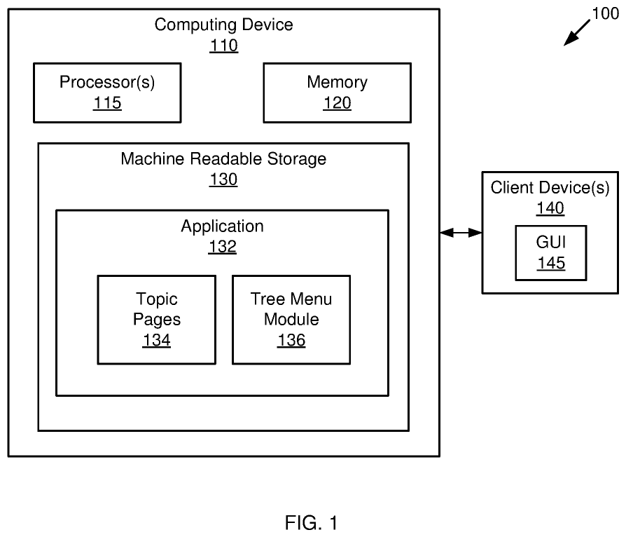

In accordance with some implementations, examples are provided for generating a tree menu with a snapshot window. As used herein, a “tree menu” is a graphical control element that presents a hierarchical view of multiple topics, such that a parent topic at a first level can be linked to any number of child topics at lower levels of the tree menu. In some implementations, the tree menu may include graphical elements (referred to herein as “topic links”) that are user-selectable to cause display of topic pages. Each topic page may be displayed in a separate window of a graphical interface (referred to herein as a “topic window”). As described further below with reference to FIGS. 1-5, some implementations include displaying a window (referred to as a “snapshot window”) that includes snapshots of open topic windows. As used herein, a “snapshot” is a graphical representation of a particular topic window. In some examples, each snapshot and its associated topic link may be indicated with a unique color. In this manner, the snapshot window may allow the user to quickly navigate between various open topic windows. Accordingly, some examples may provide improved tree menu functionality.

FIG. 1 is a schematic diagram of an example system 100, in accordance with some implementations. In some examples, the system 100 may include a computing device 110 and client device(s) 140. The computing device 110 may be, for example, a computer, a portable device, a server, a network device, a communication device, etc. Further, the computing device 110 may be any grouping of related or interconnected devices, such as a blade server, a computing cluster, and the like. Furthermore, in some implementations, the computing device 110 may be a specialized device or appliance.

As shown, the computing device 110 can include processor(s) 115, memory 120, and machine-readable storage 130. The processor(s) 115 can include a microprocessor, microcontroller, processor module or subsystem, programmable integrated circuit, programmable gate array, multiple processors, a microprocessor including multiple processing cores, or another control or computing device. The memory 120 can be any type of computer memory (e.g., dynamic random access memory (DRAM), static random-access memory (SRAM), etc.). In some implementations, the machine-readable storage 130 can include non-transitory storage media such as hard drives, flash storage, optical disks, etc. As shown, the machine-readable storage 130 may store an application 132 using topic pages 134 and a tree menu module 136.

As shown in FIG. 1, in some implementations, the application 132 may be implemented as instructions and data stored in the machine-readable storage 130. However, the application 132 can be implemented in any suitable manner. For example, some or all of the application 132 could be hard-coded as circuitry included in the processor(s) 115 and/or the computing device 110. In other examples, some or all of the application 132 could be implemented on a remote computer (not shown), as web services, and so forth. In yet other examples, the application 132 may be implemented in one or more controllers of the computing device 110.

In some implementations, the application 132 may include topic pages 134, with each topic page 134 including information regarding a particular topic. In some examples, the topic pages 134 may be organized in a hierarchical manner, with higher-level pages 134 covering broad topics, and lower-level pages 134 covering narrower sub-topics. In some examples, the topic pages 134 may be separate web pages, GUI screens, and so forth.

In some implementations, the computing device 110 can interface with client device(s) 140, and enable a user (not shown in FIG. 1) of the client device 140 to access the application 132. For example, the client device 140 may display a graphical user interface (GUI) 145 that allows the user to access and/or view the topic pages 134. In some examples, the client device(s) 140 may include a remote terminal or computer that is connected to the computing device via a wired or wireless network. In other examples, the client device 140 may comprise a display screen coupled to (or included in) the computing device 110. In some implementations, the application 132 may be a web application, and the GUI 145 may be a web browser.

In some implementations, the tree menu module 136 may include functionality to generate a tree menu based on the topic pages 134. For example, the application 132 may use or interact with the tree menu module 136 to generate a tree menu in the GUI 145 to allow a user to navigate and access the topic pages 134. In some examples, the generated tree menu may include topic links corresponding to the topic pages 134. When a user selects a particular topic link in the tree menu, the GUI 145 may display a corresponding topic page 134 in an individual topic window. In some examples, the tree menu may be organized in a hierarchical manner, but may allow a user to access the topic pages 134 in any order. For example, a user may select any topic link in the tree menu without following the order in which the topic links are listed in the tree menu.

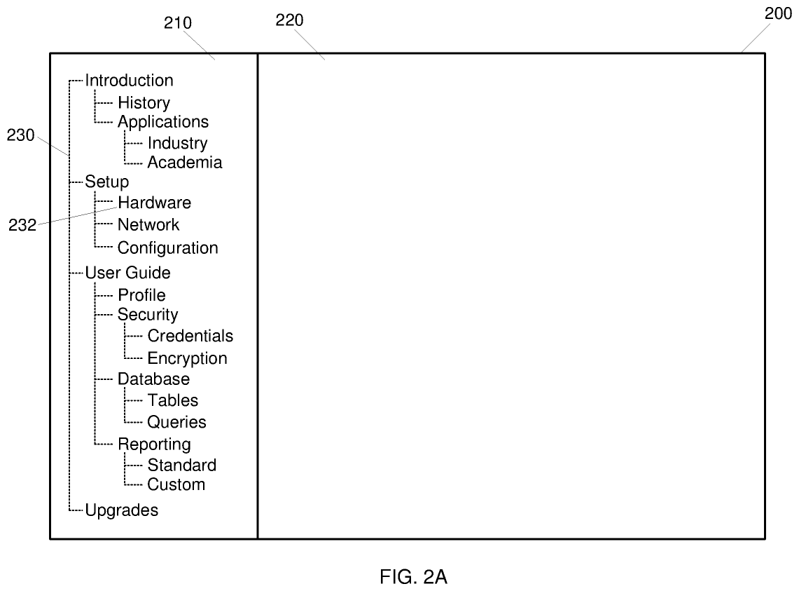

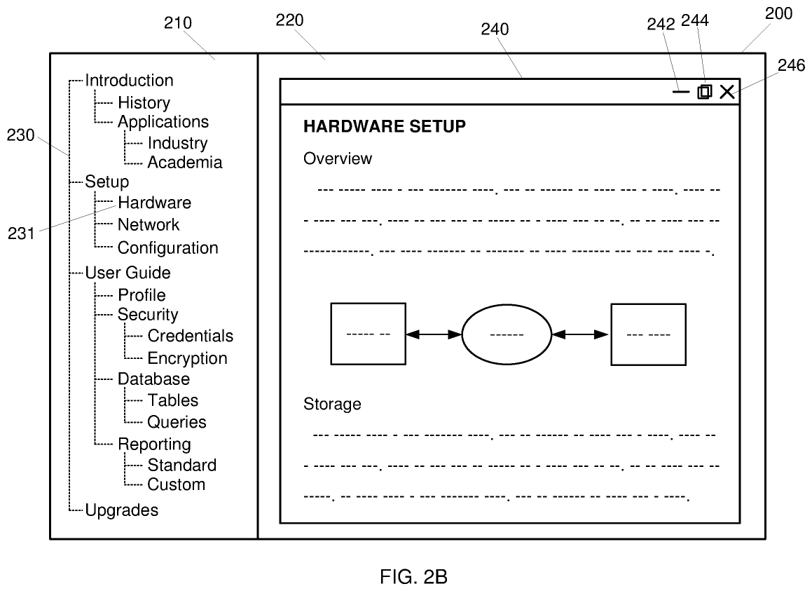

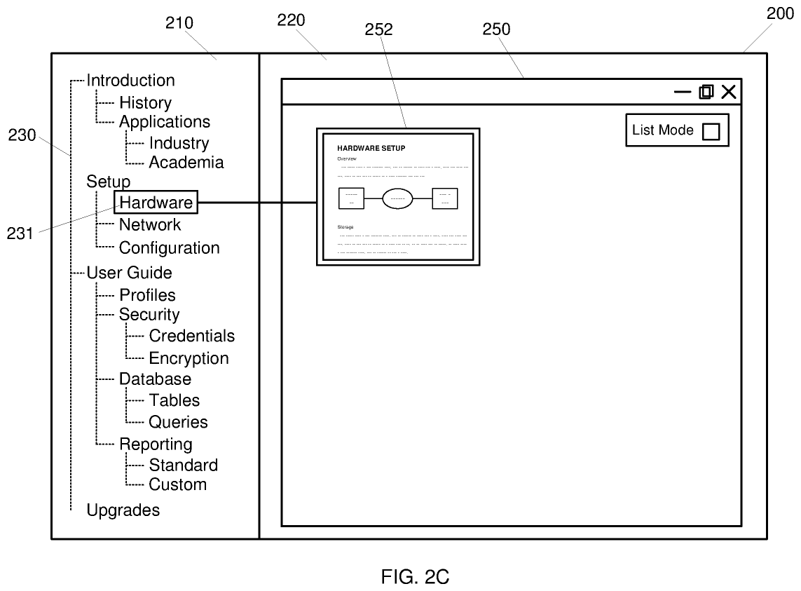

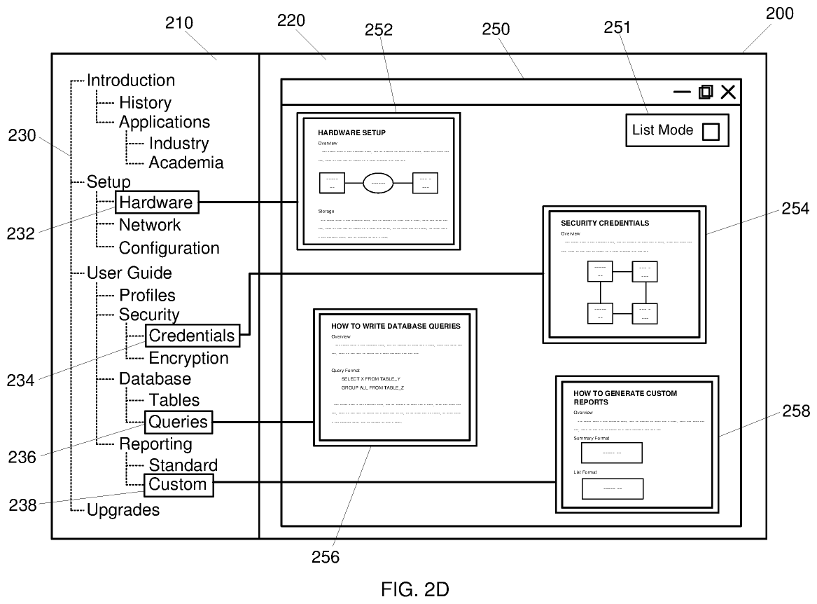

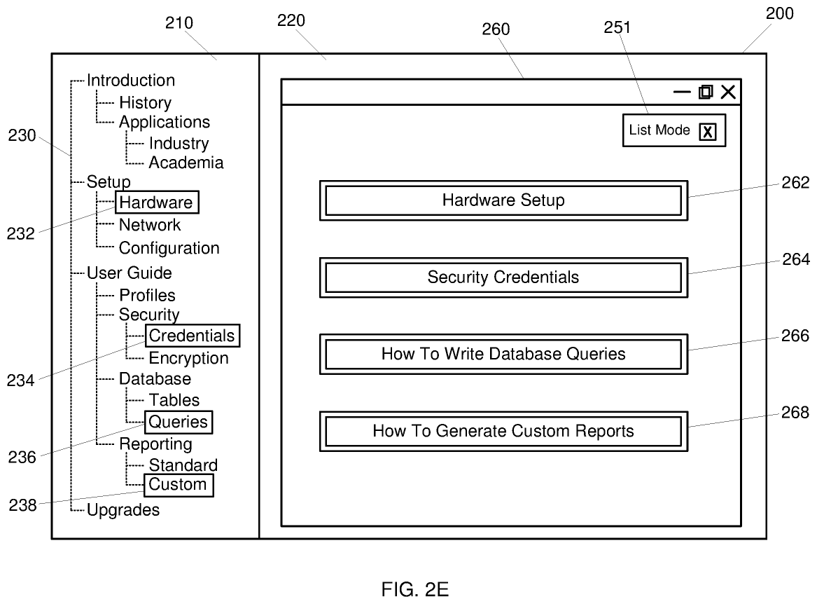

In some implementations, the tree menu module 136 may include functionality to generate a snapshot window associated with a tree menu. The snapshot window may include snapshots of one or more topic windows that have been minimized by the user. In some examples, each snapshot may be a graphical representation (e.g., a thumbnail image) of an associated topic window that is currently open. Further, in some examples, each snapshot may be a static image of the associated topic window at a particular point in time (e.g., as displayed in GUI 145 at the time that the topic window is minimized by the user). The snapshot window is described further below with reference to FIGS. 2A-2E.

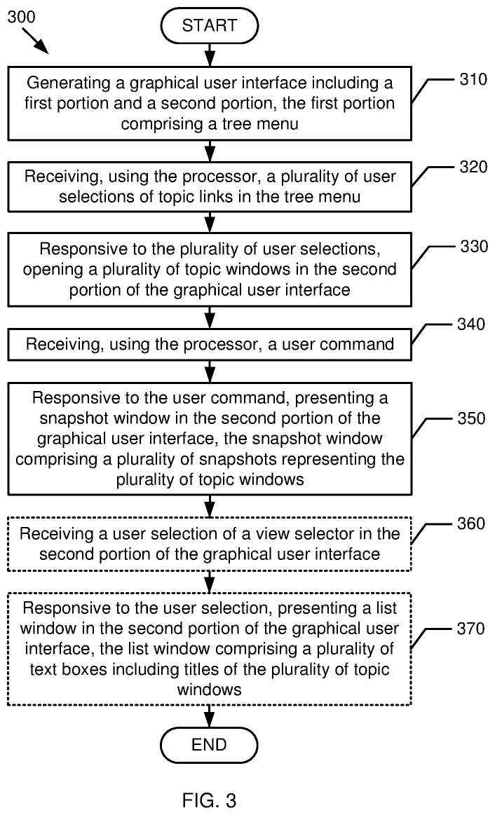

Referring now to FIGS. 2A-2E, shown are illustrations of an example user interface 200 in accordance with some implementations. As shown in FIG. 3A, the user interface 200 may include separate interface portions, including a menu portion 210 and a data display portion 220. The menu portion 210 and the data display portion 220 may be two distinct portions of the user interface 200 that are displayed concurrently. In some implementations, the user interface 200 may be generated by the application 132 (shown in FIG. 1).

As shown in FIG. 2A, in some examples, the menu portion 210 of the user interface 200 may include a tree menu 230 to allow a user to access and view multiple data pages or screens (e.g., topic pages 134 shown in FIG. 1). The tree menu 230 may include topic links 231 organized in a hierarchy, with parent pages covering broad topics, and child pages covering narrower sub-topics. In some examples, each topic link 231 may include text describing or otherwise indicating an associated topic page.

In one or more implementations, a user selection of a particular topic link 231 (e.g., by a mouse click, screen touch, voice command, etc.) may cause display of the associated topic page in the data display portion 220. For example, referring now to FIG. 2B, assume that a user selects the “Hardware” topic link 231 that is under the “Setup” category in the tree menu 230. As shown, in response to this user selection, the “Hardware Setup” topic window 240 may be displayed in the data display portion 220. In some examples, the topic window 240 may display a topic page including information (e.g., text, graphics, video, audio, etc.) related to a particular topic. In some examples, each topic page that is selected via the tree menu 230 is displayed in a separate topic window in the data display portion 220.

In some implementations, the topic window 240 may include a minimization control 242, a maximization control 244, and a close control 246. The maximization control 244 may be selected to cause the topic window 240 to be maximized (i.e., to substantially fill the data display portion 220). The close control 246 may be selected to close the topic window 240. The minimization control 242 may be selected to cause the topic window 240 to be minimized (i.e., to remain open but hidden in the user interface 200). As used herein, an “open” window refers to a window that is either visible or minimized in the user interface 200. For example, an open window has been opened (e.g., by selecting the tree menu 230) but has not yet been closed in the user interface 200 (e.g., by selecting the close control 246).

In some implementations, the data display portion 220 may display a snapshot of a topic window that is currently open (i.e., visible or minimized) in the user interface 200. For example, referring to FIGS. 2B-2C, assume that the topic window 240 is minimized, and the data display portion 220 then displays the snapshot window 250. As shown, the snapshot window 250 includes a snapshot 252 that represents the topic window 240. The snapshot window 250 may be displayed in response to a user command (e.g., text command, voice command, user gesture, selection of a screen control, and so forth), in response to a pre-defined event or state in the user interface 200, in response to a pre-defined event or state in an application (e.g., application 132 shown in FIG. 1), and so forth.

In one or more implementations, the snapshot window 250 may be displayed in response to a user command to minimize a topic window. For example, referring to FIGS. 2B-2C, a selection of the minimization control 242 may minimize the topic window 240 and cause the snapshot window 250 to be displayed. Note that, in the examples of FIGS. 2B-2C, the snapshot 252 is a reduced-size image (e.g., a thumbnail) of the associated topic page 240. However, it is contemplated that the snapshot 252 may include any other representation of the topic page 240.

In some implementations, the data display portion 220 may display snapshots of multiple topic windows that are currently open in the user interface 200. For example, referring to FIG. 2D, assume that the user has opened four topic windows by selecting four different topic links in the tree menu 230. Accordingly, as shown in FIG. 2D, the snapshot window 250 may include four snapshots 252, 254, 256, 258 that represent the four topic windows that are currently open. In some examples, the snapshot window 250 may only include snapshots of topic windows that have individually been minimized by a user minimization command.

In one or more implementations, the user can select one of the snapshots 252, 254, 256, 258, and in response the corresponding topic window may be displayed in the data display portion 220. For example, if a user selects snapshot 252, the “Hardware Setup” topic window 240 (shown in FIG. 2B) may be displayed in the data display portion 220 (e.g., is maximized in or is otherwise brought to the foreground of the data display portion 220). In this manner, the snapshot window 250 may allow the user to visually and efficiently navigate among various open topic windows.

As shown in FIG. 2D, in some implementations, the snapshot window 250 may include topic markers 232, 234, 236, 238 that indicate the topic links that are associated with the snapshots 252, 254, 256, 258. For example, the topic marker 232 indicates the “Hardware” topic link that was selected to display the topic window 240 (titled “Hardware Setup”) represented by the snapshot 252. In some implementations, the topic markers 232, 234, 236, 238 may include graphic identifiers (e.g., colors, patterns, highlights, labels, symbols, animations, etc.) that are displayed with the snapshots 252, 254, 256, 258 and their associated topic links (i.e., the topic links that cause the display of the topic windows represented by the snapshots 252, 254, 256, 258). For example, the topic marker 232 may be a border of a unique color that is shown around the snapshot 252 and the “Hardware” topic link. Further, in some implementations, the topic markers 232, 234, 236, 238 may include visual connectors (e.g., lines) that link the snapshots 252, 254, 256, 258 to their associated topic links.

In one or implementations, the number of snapshots included in the snapshot window 250 may be limited by a predefined threshold (e.g., a maximum of ten snapshots). In such implementations, the snapshots that are displayed may be selected by age (e.g., the most recently accessed snapshots), by frequency of use (e.g., the most frequently accessed snapshots), and so forth. In some implementations, the positions of the snapshots in the snapshot window 250 may be defined by a stored data structure (e.g., a position template). Further, in some implementations, the order of the snapshots in the snapshot window 250 may align with or match the order of the associated topic links in the tree menu 230 (e.g., from top to bottom).

In some implementations, the snapshot window 250 may include a view selector 251. The view selector 251 may be a graphical control that allows a user to select between the snapshot window 250 and an alternative window that lists the open topic windows. For example, referring to FIG. 2E, assume that the user has selected the view selector 251 to switch the snapshot window 250 to a list window 260. As shown, the list window 260 may include text boxes 262, 264, 266, 268 that include the titles of four open topic windows. In some examples, the text boxes 262, 264, 266, 268 include the full text titles of the corresponding topic windows.

In some implementations, the user can select one of the text boxes 262, 264, 266, 268, and in response the corresponding topic window may be displayed in the data display portion 220. For example, if a user selects text box 262, the “Hardware Setup” topic window 240 (shown in FIG. 2B) may be displayed in the data display portion 220. In some examples, the list window 260 may allow the user to easily determine the full titles of open topic windows, and thereby allow the user to quickly navigate to a specific topic window.

In some implementations, the list window 260 may include the topic markers 232, 234, 236, 238 to indicate the topic links that are associated with the text boxes 262, 264, 266, 268. For example, the text box 262 and the topic marker 232 may each have a visual indication (e.g., a border of a unique color) that indicates the “Hardware” topic link is associated with the text box 262. In some examples, the view selector 251 may be used to switch between the list window 260 and the snapshot window 250 (shown in FIG. 2D). In some implementations, switching between the list window 260 and the snapshot window 250 may involve changing the content of a single window between a view of snapshots and a list of text boxes.

In one or implementations, the number of text boxes included in the list window 260 may be limited by a predefined threshold. In such implementations, the text boxes that are displayed may be selected by age, by frequency of use, and so forth. In some implementations, the order of the text boxes in the list window 260 may match the order of the associated topic links in the tree menu 230.

Note that, while FIGS. 1-2E show example implementations, other implementations are possible. For example, it is contemplated that the functionality of the client device 140 may be included in the computing device 110. In another example, it is contemplated that any of the components of the client device 140 and/or the computing device 110 may be combined. In yet another example, it is contemplated that the client device 140 and/or the computing device 110 may include additional components. In still another example, it is contemplated that the user interface 200 may include additional elements, fewer elements, a different arrangement of elements, different types of elements (e.g., controls implemented as pop-up menus, dialog boxes, sliders, buttons), and so forth. In a further example, it is contemplated that the tree menu module 136 may be external to the application 132, may be external to the computing device 110, may be implemented on the client device 140, and so forth. Other combinations and/or variations are also possible.

Referring now to FIG. 3, shown is an example process 300 for generating a graphical user interface, in accordance with some implementations. The process 300 may be performed by the system 100 shown in FIG. 1. The process 300 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 300 may be described below with reference to FIGS. 1-2E, which show examples in accordance with some implementations. However, other implementations are also possible.

Block 310 may include generating, using a processor, a graphical user interface including a first portion and a second portion, the first portion including a tree menu. For example, referring to FIGS. 1-2A, the application 132 may generate the user interface 200 including a menu portion 210 and a data display portion 220. The menu portion 210 may include a tree menu 230 to allow a user to access and view multiple data pages or screens (e.g., topic pages 134 shown in FIG. 1).

Block 320 may include receiving, using the processor, a plurality of user selections of topic links in the tree menu. Block 330 may include, responsive to the plurality of user selections, opening a plurality of topic windows in the second portion of the graphical user interface. For example, referring to FIGS. 1-2B, the application 132 may receive a series of user selections of topic links 231 included in the tree menu 230. In response to the series of user selections, the application 132 may open a series of topic windows (e.g., topic window 240) in the data display portion 220.

Block 340 may include receiving, using the processor, a user command. Block 350 may include, responsive to the user command, presenting a snapshot window in the second portion of the graphical user interface, the snapshot window comprising a plurality of snapshots representing the plurality of topic windows. For example, referring to FIG. 1-2D, the application 132 may receive a user selection of the minimization control 242 in the topic window 240. In response to the user command, the topic window 240 is minimized, and the snapshot window 250 is presented in the data display portion 220. The snapshot window 250 includes snapshots 252, 254, 256, 258 that represent four topic windows that are minimized in the data display portion 220. In some examples, selecting one of the snapshots 252, 254, 256, 258 may cause the associated topic window to be displayed in the data display portion 220.

The process 300 may optionally include blocks 360 and 370. Block 360 may include receiving a user selection of a view selector in the second portion of the graphical user interface. Block 370 may include, responsive to the user selection, presenting a list window in the second portion of the graphical user interface, the list window comprising a plurality of text boxes including titles of the plurality of topic windows. For example, referring to FIG. 1-2E, the application 132 receives a user selection of the view selector 251 in the snapshot window 250, and in response switches the snapshot window 250 to the list window 260. The list window 260 shows text boxes 262, 264, 266, 268 that include the titles of the four topic windows that are minimized in the data display portion 220. In some examples, selecting one of the text boxes 262, 264, 266, 268 may cause the associated topic window to be displayed in the data display portion 220. After block 370, the process 300 is completed.

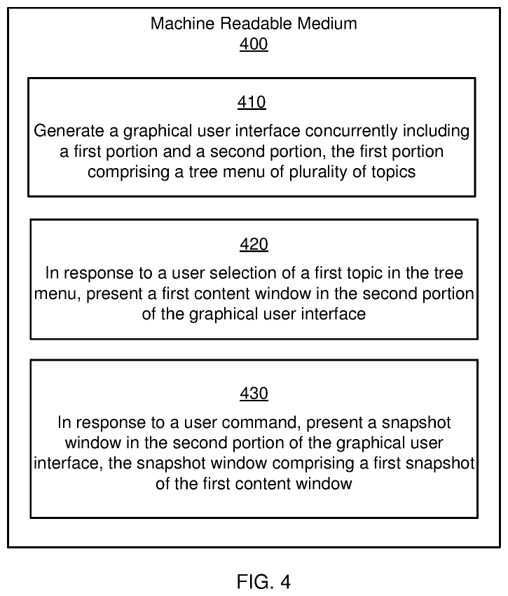

Referring now to FIG. 4, shown is a machine-readable storage medium 400 storing instructions 410-430, in accordance with some implementations. The instructions 410-430 can be executed by any number of processors (e.g., the processor(s) 115 shown in FIG. 1). The machine-readable storage medium 400 may be any non-transitory computer readable medium, such as an optical, semiconductor, or magnetic storage device.

Instruction 410 may be executed to generate a graphical user interface including a first portion and a second portion, the first portion including a tree menu comprising a plurality of topic links. Instruction 420 may be executed to, in response to a user selection of a first topic link in the tree menu, present a first topic window in the second portion of the graphical user interface. Instruction 430 may be executed to, in response to a user command, present a snapshot window in the second portion of the graphical user interface, the snapshot window comprising a first snapshot of the first topic window.

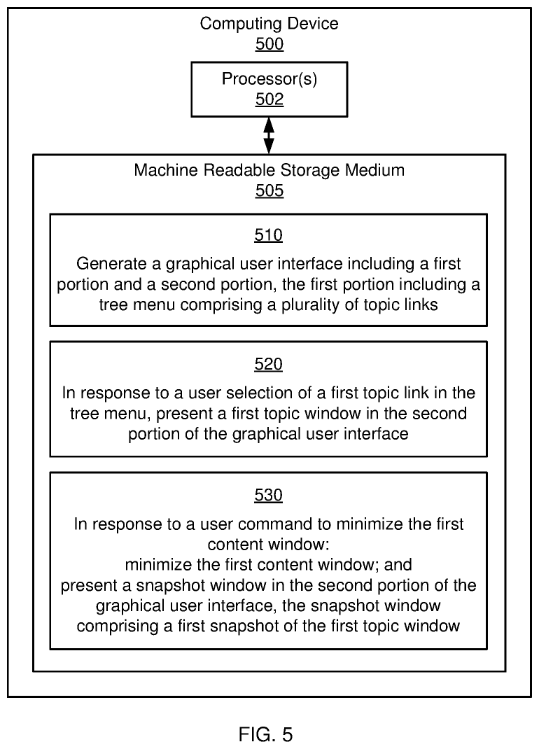

Referring now to FIG. 5, shown is a schematic diagram of an example computing device 500. In some examples, the computing device 500 may correspond generally to the computing device 110 shown in FIG. 1. As shown, the computing device 500 may include a hardware processor(s) 502 and machine-readable storage medium 505. The machine-readable storage medium 505 may be a non-transitory medium, and may store instructions 510-530. The instructions 510-530 can be executed by the hardware processor(s) 502.

Instruction 510 may be executed to generate a graphical user interface including a first portion and a second portion, the first portion including a tree menu comprising a plurality of topic links. Instruction 520 may be executed to, in response to a user selection of a first topic link in the tree menu, present a first topic window in the second portion of the graphical user interface. Instruction 530 may be executed to, in response to a user command to minimize the first content window: minimize the first content window, and present a snapshot window in the second portion of the graphical user interface, the snapshot window comprising a first snapshot of the first topic window.

In accordance with some implementations, examples are provided for generating a tree menu with a snapshot window. Some implementations include displaying a snapshot window that includes graphical representations of open topic windows. In some implementations, each snapshot and its associated topic link may be indicated with a unique color. In some implementations, the snapshot window may improve the graphical user interface by allowing the user to efficiently navigate between multiple open topic windows.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a hardware processor; and
a machine-readable storage medium storing instructions, the instructions executable by the hardware processor to:
generate a graphical user interface including a first portion and a second portion, the first portion including a tree menu comprising a plurality of topic links;
in response to a user selection of a first topic link in the tree menu, present a first topic window in the second portion of the graphical user interface; and
in response to a user command to minimize the first content window:
minimize the first content window; and
present a snapshot window in the second portion of the graphical user interface, the snapshot window comprising a first snapshot of the first topic window.

2. The computing device of claim 1, wherein the snapshot window comprises a plurality of snapshots of a plurality of topic windows, wherein each of the plurality of topic windows is open in the second portion of the graphical user interface.

3. The computing device of claim 2, wherein each snapshot of the plurality of snapshots is associated with a unique topic link in the tree menu.

4. The computing device of claim 3, wherein each snapshot and its associated topic link are indicated by a unique color.

5. The computing device of claim 3, wherein each snapshot and its associated topic link are indicated by a line connector.

6. The computing device of claim 1, wherein the instructions are executable by the hardware processor to:
in response to a user selection of the first snapshot, maximize the first topic window in the second portion of the graphical user interface.

7. The computing device of claim 1, wherein the instructions are executable by the hardware processor to:
in response to a user selection of a view selector in the second portion of the graphical user interface, present a list window in the second portion of the graphical user interface, the list window comprising a first text box including a title of the first topic window.

8. The computing device of claim 7, wherein the list window comprises a plurality of text boxes, wherein each of the plurality of text boxes includes a unique title of a topic window that is open in the second portion of the graphical user interface.

9. A method for presenting topic windows, comprising:
generating, using a processor, a graphical user interface including a first portion and a second portion, the first portion including a tree menu;
receiving, using the processor, a plurality of user selections of topic links in the tree menu;
responsive to the plurality of user selections, opening a plurality of topic windows in the second portion of the graphical user interface;
receiving, using the processor, a user command; and
responsive to the user command, presenting a snapshot window in the second portion of the graphical user interface, the snapshot window comprising a plurality of snapshots representing the plurality of topic windows.

10. The method of claim 9, wherein the user command is a command to minimize one of the plurality of topic windows.

11. The method of claim 9, further comprising:
displaying a plurality of topic markers in the graphical user interface, wherein each of the plurality of topic markers is a graphic identifier that is displayed with a snapshot and its associated topic link.

12. The method of claim 11, wherein each of the plurality of topic markers has a unique color.

13. The method of claim 9, further comprising:
receiving a user selection of a view selector in the second portion of the graphical user interface,
responsive to the user selection, presenting a list window in the second portion of the graphical user interface, the list window comprising a plurality of text boxes including titles of the plurality of topic windows.

14. The method of claim 9, further comprising:
in response to a user selection of a first snapshot of the plurality of snapshots, maximize a first topic window of the plurality of topic windows in the second portion of the graphical user interface.

15. An article comprising a non-transitory machine-readable storage medium storing instructions that upon execution cause a processor to:
generate a graphical user interface including a first portion and a second portion, the first portion including a tree menu comprising a plurality of topic links;
in response to a user selection of a first topic link in the tree menu, present a first topic window in the second portion of the graphical user interface;
in response to a user command, present a snapshot window in the second portion of the graphical user interface, the snapshot window comprising a first snapshot of the first topic window.

16. The article of claim 15, wherein the user command is a command to minimize the first content window.

17. The article of claim 15, wherein the snapshot window comprises a plurality of snapshots of a plurality of topic windows, wherein each of the plurality of topic windows is minimized in the second portion of the graphical user interface.

18. The article of claim 17, wherein each snapshot is associated with a unique topic link in the tree menu, and wherein each snapshot and its associated topic link are indicated by a unique color.

19. The article of claim 18, wherein each snapshot and its associated topic link are indicated by a line connector.

20. The article of claim 15, wherein the instructions cause the processor to:
in response to a user selection of a view selector in the second portion of the graphical user interface, present a list window in the second portion of the graphical user interface, the list window comprising a first text box including a full title of the first content window.
